(19) United States
(12) Patent Application Publication
(10) Pub. No.: US 2005/0240460 A1
(43) Pub. Date: Oct. 27, 2005

(54) Method to improve cooperation of business entities

(76) Inventor: Keith Paul Bahde, Fayetteville, GA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/110,038

(22) Filed: Apr. 20, 2005

Related U.S. Application Data
(60) Provisional application No. 60/564,234, filed on Apr. 21, 2004.

(51) Int. Cl. G06F 17/60

(52) U.S. Cl. 705/9; 705/1

(57) ABSTRACT

A method and tool to facilitate synergistic cooperation of business entities. Representatives of each of two (or more) business entities can collaborate and perform (a) identifying a plurality of strengths for a first entity and a second entity; (b) determining a designation designating whether each of the plurality of strengths is critical or collateral; (c) choosing whether each of the plurality of strengths and respective designations has common ground between the first entity and the second entity; (d) selecting a first strength that is designated as critical and has common ground and a second strength that is designated as critical and has common ground; and (e) determining a directive which is based on the first strength and the second strength.

### CROSS REFERENCE TO RELATED APPLICATIONS

This application claims benefit of provisional application 60/564,234, filed on Apr. 21, 2004, entitled, “Riding the Whitewater: a Social Constructionist Approach to the Mergers and Acquisitions Integration Process and the Role of the Integration Manage”, which is incorporated by reference herein in its entirety.

### BACKGROUND OF THE INVENTION

1. Field of the Invention

The present invention is directed to a method, apparatus, and computer readable storage medium to facilitate integrating two separate entities.

2. Description of the Related Art

Two separate entities, such as related companies, commonly form a joint venture or other cooperative relationship wherein the different entities may have different strengths and weaknesses. One challenge of such a cooperation is to choose an ideal set of goals that the two entities can strive to achieve which will encourage success of the cooperative effort.

Therefore, what is needed is a way in which two cooperative entities can work together effectively and choose an ideal set of goals together.

### SUMMARY OF THE INVENTION

It is an aspect of the present invention to provide a method for two cooperating parties to choose an effective set of goals to further a cooperative effort.

The above aspects can be obtained by a method that includes (a) identifying a plurality of strengths for a first entity and a second entity; (b) determining a designation designating whether each of the plurality of strengths is critical or collateral; (c) choosing whether each of the plurality of strengths and respective designations has common ground between the first entity and the second entity; (d) selecting a first strength that is designated as critical and has common ground and a second strength that is designated as critical and has common ground; and (e) determining a directive which is based on the first strength and the second strength.

The above aspects can also be obtained by a method that includes (a) identifying a plurality of strengths for a first entity and a second entity; (b) determining a designation designating whether each of the plurality of strengths is critical or collateral; (c) choosing whether each of the plurality of strengths and respective designations has common ground between the first entity and the second entity; and (d) identifying as a first category strengths which are designated as critical and which have common ground.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is an exemplary diagram illustrating assigning categories to different quadrants, according to an embodiment; and

FIG. 2 is an exemplary diagram illustrating development of subordinate goals, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present invention relates to a method and tool (which can include a software tool to implement the invention) which can assist parties in synergizing two entities.

Table I below illustrates a method of assisting parties in synergizing the two entities.

TABLE I

| | |
|---|---|
| (1) | What are the critical success factors (CSFs) of each of the combining organizations, which have |
| | implications for the combined organization? CSFs are those rare strengths without which an |
| | organization would fundamentally cease to be the organization as we currently know it. Well- |
| | known examples might include innovation at 3M or quality at Toyota. |
| (2) | After the CSFs are identified, revisit the list and candidly assess those, which are critical versus |
| | those that are collateral. The latter are strengths which, although valuable, are competencies |
| | which not absolutely critical to the success of the combined organization. |
| (3) | Determine the degree of common ground achieved during the first two steps. The determination |
| | of common ground need not imply absolute unanimity of thought, but should imply general |
| | consensus. |
| (4) | Drawing from the CSFs identified above, determine the synergistic combinations of |
| | complementary resources (SCORE) that provide the best opportunities for the creation of |
| | economic value. These synergistic combinations become the focus of the integration strategy. |
| (5) | Create preliminary actions plans to achieve each of the synergistic combinations identified |
| | above. Identify the key people responsible for taking these actions as well as the target dates for |
| | accomplishing these actions. |
| (6) | Finally, develop a superordinate goal that has the potential to energize the combined |
| | organization to pursue the integration strategy. Examples might include the development of a key |
| | competitive advantage as compared to rivals, or the creation of an innovative or special product |
| | or service that is unique to the combined organization. |

Table I can be considered to be a flowchart. Table I shows an integration strategy development process that can be referred to as the SCORE Strategy Development process. The process retains the focus from this method on identifying strengths rather than creating solutions to perceived problems. This focus on strengths is reflected in question one in Table I, which is designed to identify the critical success factors (CSFs) in place at each of the combining organizations. The SCORE method can move immediately into an evaluative mode in question two by encouraging those taking part in this exercise to “candidly assess those [strengths] which are critical versus those which are collateral.” The intent is to quickly develop a focus on only those factors, which are truly critical to the combination process and avoid the tendency to become distracted by collateral issues.

Next, in question three the group is asked to evaluate the degree of common ground regarding the CSFs among the group. This is important since reaching consensus about an integration strategy is a critical element of success. That is, if consensus cannot be reached regarding the CSFs in place at each of the combining organizations, if will be very difficult to develop consensus around a strategy designed to pursue the SCORE which might be constructed from these strengths.

Operations 1 and 2 from Table I are illustrated in a hypothetical example illustrated in Table II. This example involves a group comprised of two organizations, (NYC and EM). These two organizations want to work together in an effective manner and choose a productive set of goals. Table II illustrates a list of strengths for each company, whether the strengths are considered critical or collateral by the two companies, and whether there is common ground of the critical or collateral designation. If both companies are in agreement that the strength is critical or collateral, then there is common ground.

TABLE II

| | | Critical | Common |
|---|---|---|---|
| | Sustainable | Or | Ground? |
| | Strengths | Collateral? | Yes or No? |
| 1 | Our ability to service our customers | Critical | Yes |
| | (NYC) | | |
| 2 | Market knowledge/customer | Critical | Yes |
| | relationships (NYC) | | |
| 3 | Relationship with local union (NYC) | Collateral | Yes |
| 4 | Product design capabilities (NYC) | Collateral | No |
| 5 | Breadth of commercial product line (EM) | Critical | Yes |
| 6 | Capital resources (EM) | Collateral | Yes |
| 7 | Manufacturing expertise (EM) | Critical | No |
| 8 | Effective information systems (EM) | Collateral | No |

In question four from Table I, the group is asked to identify opportunities to combine the CSFs identified in the first three steps in order to create opportunities for SCORE. In question five from Table I the group focuses on the actions plans required to pursue these synergistic combinations, and question six encourages the group to identify a superordinate goal which can be used to catalyze the change process. Examples of superordinate goals might include the development of a key competitive advantage as compared to rivals, or the creation of an innovative or special product or service that is unique to the combined organization. The intent of this final step is to generate enthusiasm for the change process by creating passion for the combination objectives.

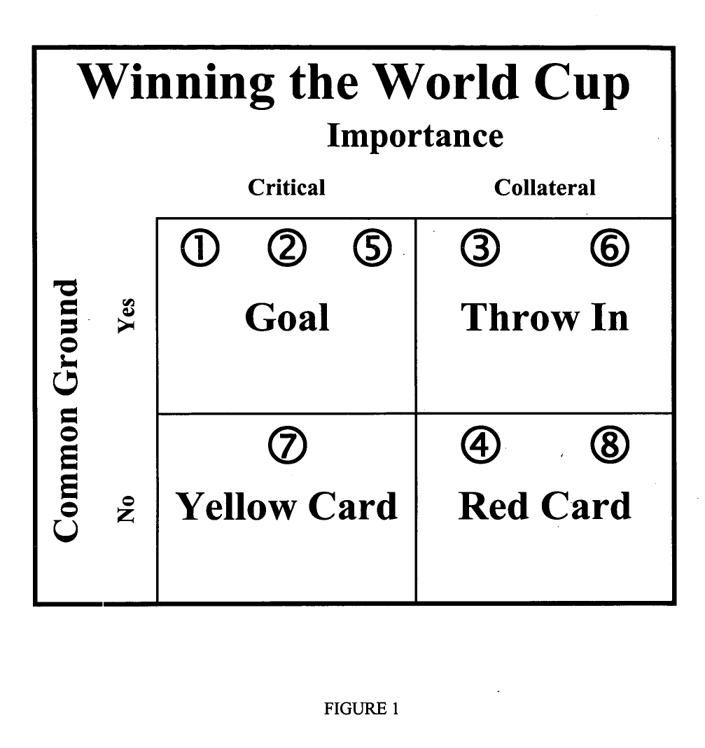

FIG. 1 is an exemplary diagram illustrating assigning categories to different quadrants, according to an embodiment.

FIG. 1 can also be considered a “brainstorming chart” and can be used to facilitate the generation of strengths and evaluate whether the strength is critical or collateral for the combining organization, as well as the degree of consensus reached in this evaluation. As FIG. 1 shows, a hypothetical example of how this tool might have been used for the NYC combination is depicted. For this example, assume that the two principals of the NYC company and the entire senior management staff of Electrical Manufacturer met offsite for several days prior to the announcement of the acquisition. Further, assume that the meeting had been planned for some time, and that the acquired principals knew both what to expect from the session and why the members of the acquiring company felt it was important to conduct the session. Having these discussions prior to the session might have avoided the reaction of one of the acquired principals to the initial integration strategy session who “felt put upon . . . [and that he] was being managed” during the initial strategy session.

In the pre-announcement session, the members of the combining organizations would have been asked to brainstorm a list of strengths using question one from Table I. Next, questions two and three in Table I would have led the group to make the evaluations recorded in the second and third columns of Table II. In actuality, the participants might have filled several charts during the brainstorming of strengths and then later designated many of these as only collateral to the success of the combined organization. However, for purposes of this illustration, it has been assumed that the group worked very efficiently and required only a single chart to reach consensus.

The exercise of completing the chart shown in Table II would likely lead to a large amount of data, much of which would not be pertinent to the challenge of creating a highly focused integration strategy.

Thus, the summary chart shown in FIG. 1 is used to create a highly visual image of the consensus developed at this point. The chart presents each the strengths identified using the methods above in one of four quadrants depending on its designation as a critical or collateral strength and the degree of consensus about this designation.

FIG. 1 employs a soccer metaphor (although of course other metaphors can be used as well) to appeal to combining groups worldwide, a strength designated as collateral about which there is little consensus is placed in the lower-right quadrant and would be awarded a red card. In soccer, this indicates a penalty so serious that the perpetrator is removed from the game. During an integration strategy development process, these items can be removed from further consideration.

Strengths designated as collateral about which there is a high degree of consensus would be placed in the upper-right quadrant and would be awarded a throw in. In soccer, this is a free throw that can be directed toward a teammate. As such, this is not a particularly good or bad thing, and during an integration strategy development process these items would likely be ignored. However, creating a shared understanding of collateral strengths around which there is a high degree of consensus could become an important component of later strategies.

Strengths designated as critical but about which there is not a high degree of consensus would be placed in the lower-left quadrant and would be awarded a yellow card. In soccer, this indicates a penalty, but one which is not as serious as a red card, and the perpetrator remains in the game. During an integration strategy development process, items awarded yellow cards might present important dilemmas to the combining management team as some see these strengths as critical while others do not. Lack of consensus in these areas need not indicate that the combination process is doomed, but it certainly indicates that further work is required to get the team on the same page.

Finally, strengths designated as critical about which there is a high degree of consensus would be placed in the upper-left quadrant and would be awarded a goal. In soccer, as in other activities, the meaning of this designation is clear: These are the elements of the combining organizations that should become the focus of the integration strategy.

The process depicted in Tables II and FIG. 1 might best be completed for both the acquiring and acquired organizations before proceeding to question four in Table I. Assuming that this approach was used, the combining management team would have a highly visual identification of the CSFs in place at each organization around which there was a high level of consensus. For example, as FIG. 1 shows, the goals identified for the NYC combination included (1) the NYC company's ability to service their customers, primarily due to short lead times, (2) the NYC company's market knowledge and customer relationships, and (5) the breadth of Electrical Manufacturer's commercial product line. Following the social construction approach to M&A integration, these are the elements that are combined to construct SCORE. All other factors would be ignored, at least initially, to provide a focus on only those elements that maximize the creation of economic value.

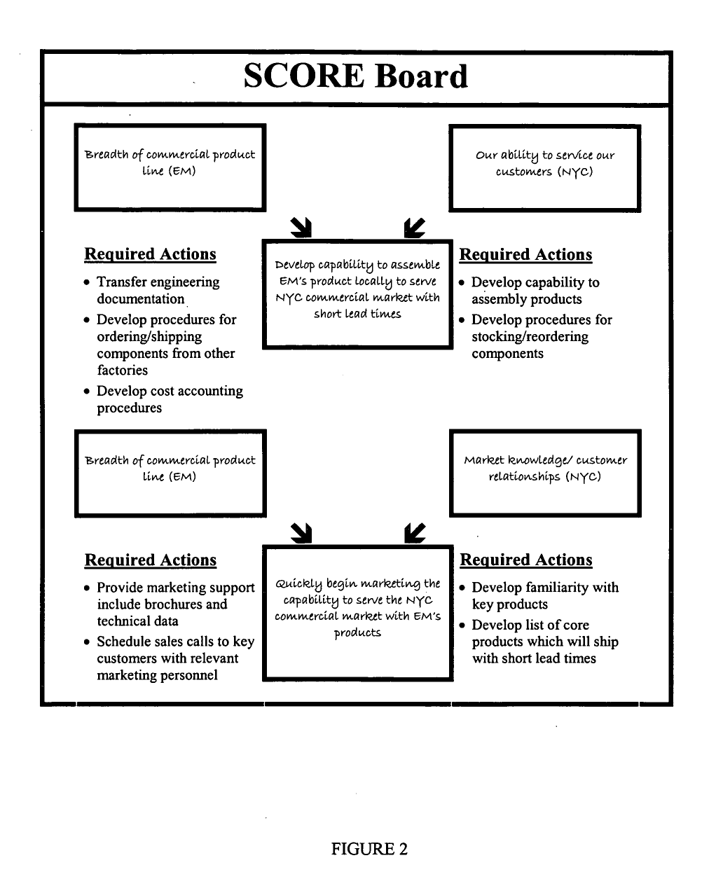

FIG. 2 is an exemplary diagram illustrating development of subordinate goals, according to an embodiment.

FIG. 2 shows a tool used to articulate SCORE (a “SCORE board”). Using combinations of the goal items charted in the upper-left quadrant of FIG. 1, the task of the combining management team is to identify unique strengths which, when combined, allow them to construct SCORE. For example, FIG. 2 shows how the three goals in the NYC case might have been combined. The first of the two SCORE combines the broad commercial product line of Electrical Manufacturer with the NYC company's ability to serve local customers. The second of the two SCORE also employs the broad commercial product line of Electrical Manufacturer, but this integration strategy is focused on marketing the unique capability created due to the combination. The required actions shown in FIG. 5 represent only a few of actions actually required to create each of these SCORE, but the list would have been adequate for a pre-announcement integration strategy. The specific actions required to address these strategies would be identified and socially constructed by the people who assumed responsibility for these tasks.

With this step completed, the foundation for an integration strategy would have been established. The items shown in FIG. 2 would become the focus of the integration strategy, and other strategies would be postponed or abandoned. With this integration strategy in place, the group would have been ready to address question five in Table I, which focuses on the articulation of a superordinate goal to provide motivation for the combination.

For example, in the NYC combination an appropriate superordinate goal might have been the opportunity to outperform a key competitor that had dominated the NYC market for many years. Since this competitor had recently closed a facility located in the NYC area as part of a cost-cutting program, the NYC combination offered a unique opportunity to penetrate a market previously unavailable.

The completion of the tools/examples shown in FIGS. 1-2 can provide several benefits to the combining NYC management team. First, completing the tools would have engaged them in dialogue regarding the elements of their organizations, which they regarded as most valuable for the combined organization. Second, this dialogue might have led to the development of a shared, core vision of how economic value was to be created as a result of the combination. Differences of opinion could have been aired and explored, and a greater degree of consensus might have been developed. Third, the completed tools would provide a tangible product of an integration strategy session which would provide a kind of evidence to all involved that the senior management teams of the combining organization had developed common ground and established a shared strategic direction for the NYC combination. Fourth, the charts could have been used immediately for conveying this direction to the whole system of people it affected. This would have provided a highly relevant language which those involved might have used to construct the reality of the combined organization. For example, if a person involved in the process observed actions taken which were inconsistent with the integration strategy, they might have drawn reference to the stated integration strategy to challenge the action. Finally, the charts could also have been immediately updated as the integration strategy emerged during post-announcement integration strategy sessions and periodic progress updates.

An advantage of the methods described herein is to help appreciate differences in language and optimizing understanding through use of language. When working with different entities, there is an existing knowledge of (1) binary distinctions and (2) organization change, and overcoming a lack of a connection of these particulars can be useful to organizational theorists and practitioners.

The way in which it is applied to methods described herein is as follows: The organization change manager can articulate two particulars that are implicated in a planned change effort. For example, consider a reference to (1) the complete line of lighting fixtures an acquiring company possessed, and (2) the close, local relationships in NYC an acquire company possessed. When combined—that is, when a novel combination of binary particulars was combined—the opportunity for incremental economic value was created. A primary challenge lies in clearly articulating this type of combination of particulars, and in authoring a narrative or metaphor that engages all who become involved in the combination effort in a concerted effort to actualize the combination in the intended way. Without a clear articulation of the potential combination of a chosen set of particulars, those who become involved in the change effort are likely to see a variety of ways in which a variety of particulars might be combined. When this happens, chaos ensues and dysfunctional conflict reigns.

Thus, benefits from the methods described herein can include an immediate airing of the myriad particulars that might be combined; a clearly articulated storyline that delimits a small subset of particulars which are to be combined in a specific way; and an intentional silencing of alterative perspectives. With this accomplished, those involved in the change effort would “sing from the same song sheet” and perform in concert rather than chaotically.

Note also that the integration manager or other leader of the combination might occasionally open an inquiry—such as a one or two day strategy session—to explore the potential for including other, silenced combinations in the change storyline, but that this window of flexibility would be closed when this inquiry period was over.

It is noted that the methods described herein (and claimed) can be implemented using a tool such as a computer. A computer can be used to prompt and/or receive answers to any of the questions from Table I (or any other inputs or outputs needed). The computer can also be used to generate outputs such as FIG. 1 and/or FIG. 2 (or any other outputs needed). The computer can also store the answers inputted, on a storage such as a CD-ROM, RAM, etc.

The example used herein is merely one example of a use of the methods described herein. Other uses can be applied as well, such as synergizing joint ventures, partnerships, large corporations, etc.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method, comprising:
identifying a plurality of strengths for a first entity and a second entity;
determining a designation designating whether each of the plurality of strengths is critical or collateral;
choosing whether each of the plurality of strengths and respective designations has common ground between the first entity and the second entity;
selecting a first strength that is designated as critical and has common ground and a second strength that is designated as critical and has common ground; and
determining a directive which is based on the first strength and the second strength.

2. A method as recited in claim 1, further comprising:
using an electronic tool to input the plurality of strengths.

3. A method as recited in claim 1, further comprising:
determining first activities to for the first entity which help achieve the directive and second activities for the second entity which help achieve the directive.

4. A method as recited in claim 1, further comprising:
illustrating a square with four quadrants, a first quadrant indicating critical strength(s) which have common ground, a second quadrant indicating critical strength(s) which do not have common ground, a third quadrant indicating collateral strength(s) which have common ground, and a fourth quadrant indicating collateral strength(s) which do not have common ground.

5. A method, comprising:
identifying a plurality of strengths for a first entity and a second entity;
determining a designation designating whether each of the plurality of strengths is critical or collateral;
choosing whether each of the plurality of strengths and respective designations has common ground between the first entity and the second entity; and
identifying as a first category strengths which are designated as critical and which have common ground.

6. A method as recited in claim 5, further comprising using an electronic tool to input the plurality of strengths.

7. A method as recited in claim 5, further comprising:
identifying as a second category strengths which are designated as collateral and which have common ground.

8. A method as recited in claim 6, further comprising:
identifying as a third category strengths which are designated as critical and which do not have common ground.

9. A method as recited in claim 7, further comprising:
identifying as a fourth category strengths which as designated as collateral and which do not have common ground.

10. A method as recited in claim 5, wherein the first category comprises goals for the organizations.

11. A method as recited in claim 9, further comprising:
outputting a chart with four quadrants, each quadrant including the first category, second category, third category, and fourth category, respectively.

12. A method to facilitate organizational change, the method comprising:
articulating novel combinations of particular aspects of organizations;
identifying valuable aspects of the articulated novel combinations; and
eliminating non-valuable aspects of the articulated novel combinations.

13. A method as recited in claim 12, further comprising:
using a computer-based tool in order to specify the articulating.
